(19) United States
(12) Patent Application Publication
(10) Pub. No.: US 2008/0314315 A1
(43) Pub. Date: Dec. 25, 2008

(54) MONITORING METHOD AND MONITORING APPARATUS FOR SEMICONDUCTOR PRODUCTION EQUIPMENT

(76) Inventors: Atsushi Yamamoto, Toyama (JP); Shuichi Fukuda, Toyama (JP)

Correspondence Address: MCDERMOTT WILL & EMERY LLP, 600 13TH STREET, NW, WASHINGTON, DC, 20005-3096, US

(21) Appl. No.: 12/143,234

(22) Filed: Jun. 20, 2008

(30) Foreign Application Priority Data
Jun. 20, 2007 (JP) 2007-162411

(51) Int. Cl. B05C 11/00

(52) U.S. Cl. 118/708

(57) ABSTRACT

In a monitoring method of the present invention, a flow voltage value corresponding to zero flow is acquired before the start of a substrate treatment by a substrate treatment apparatus. Next, a flow voltage value corresponding to a control state while the flow is controlled according to a control signal during the substrate treatment is acquired. Then, an actual flow rate is calculated according to a difference between the flow voltage value during the flow control and the flow voltage value at the time of zero flow. Further, a difference between the actual flow rate of a currently-implemented substrate treatment and the actual flow rate of the last substrate treatment is calculated, and the fluctuation of the flow control characteristic and the flow control accuracy are monitored according to the difference.

### CROSS-REFERENCE TO RELATED APPLICATION

The present application claims the benefit of Japanese Patent Application No. 2007-162411 filed Jun. 20, 2007, the subject matter of which is incorporated herein by reference.

### BACKGROUND OF THE INVENTION

1. Field of the Invention

The present invention relates to a monitoring method and a monitoring apparatus for detecting an abnormality of a semiconductor production equipment having a device that controls a throughput of a fluid (liquid, gas, etc.), such as a flow controller or a pressure controller.

2. Description of the Related Art

In a production process for a semiconductor device, a substrate treatment apparatus that is used in conjunction with a device for controlling a throughput of a liquid or gas, such as a flow controller or a pressure controller, is widely used. This substrate treatment apparatus includes a film formation apparatus and an etching apparatus that are equipped with a vacuum treatment chamber, a chemical solution coating apparatus, and a development apparatus. In this type of apparatus, for the purpose of detecting a treatment abnormality, a device state is monitored as described below.

FIG. 11 is a schematic diagram for explaining a conventional device state monitoring method. In FIG. 11, a substrate treatment apparatus 1110 is connected to a flow controller 1120. The substrate treatment apparatus 1110 enters a flow value to be set in the flow controller 1120 as an electric signal. The flow controller 1120 matches the flow rate of a liquid or gas, which is a subject for flow control, to the entered flow value by adjusting the degree of opening of a flow control valve and the like. For example, when the substrate treatment apparatus 1110 is a dry-etching apparatus, the flow controller 1120 is equivalent to a mass flow controller that controls a flow rate of process gas to be supplied to a treatment chamber of the substrate treatment apparatus 1110.

As shown in FIG. 11, the substrate treatment apparatus 1110 is equipped with a flow monitoring unit 1111 that monitors a flow control state of the flow controller 1120. The flow monitoring unit 1111, at first, converts a flow value to be set into an electric signal based upon a flow control characteristic pre-registered in the flow monitoring unit 1111. The flow control characteristic indicates a correspondence relationship between a flow control state of a flow control mechanism that physically adjusts a flow rate and an electric signal. For example, when the flow controller 1120 controls a flow rate by adjusting the degree of opening of the flow control valve, the electric signal corresponds to the degree of opening of the flow control valve one on one. A voltage value (hereafter, referred to as a flow voltage value) is usable as the electric signal. Herein, it is assumed that the flow value to be adjusted is 100 sccm and the flow voltage value corresponding to the flow value at 100 sccm is 2.5 V.

The flow monitoring unit 1111 transmits the converted flow voltage value (2.5 V) from a requested value output port 1112 as a requested value 1131. The requested value 1131 is entered into a requested value input port 1121 of the flow controller 1120. When the requested value 1131 is entered, the flow controller 1120 adjusts the flow control state of the flow control mechanism to a state corresponding to the entered requested value 1131. With this adjustment, the flow rate of the fluid that is subject for the flow control becomes a specific flow rate according to the state of the flow control mechanism. Here, the flow control mechanism becomes a state corresponding to the flow voltage value at 2.5 V. At this time, the flow controller 1120 confirms an actual flow control state of the flow control mechanism, and transmits a flow voltage value corresponding to said flow control state from a return value output port 1122 as a return value 1132. For example, when the flow control mechanism is in a state corresponding to the flow voltage value at 2.5 V, 2.5 V is transmitted as the return value 1132. Further, when the flow control mechanism is in a state corresponding to a flow voltage value different from 2.5 V, said flow voltage value is transmitted as the return value 1132.

The return value 1132 is entered into a return value input port 1113 of the flow monitoring unit 1111. Once the return value is entered, the flow monitoring unit 1111 converts the return value 1132 into a corresponding flow value based upon the pre-registered flow control characteristic. The converted flow value is displayed, for example, on a display device in the substrate treatment apparatus 1110 as a flow value of the flow controller 1120.

In this case, when the converted flow value is matched with the flow value requested to the flow controller 1120, or even when it is different from the requested flow value, if the converted flow value is within a specification range, it is determined that the normal flow control is implemented. Further, when the converted flow value is not within the specification range, it is determined that the flow control is abnormal. In other words, according to the above-mentioned configuration, whether or not the flow control as requested by the substrate treatment apparatus 1110 is implemented by the flow controller 1120 can be monitored.

As the related art where the monitoring of the device state is used, for example, the invention described in Japanese Patent Application Laid-Open No. 2002-129337 is mentioned.

### SUMMARY OF THE INVENTION

In the above-mentioned conventional device state monitoring method, it is premised that the flow controller 1120 implements the flow control in accordance with the flow control characteristic pre-registered in the flow monitoring unit 1111. In other words, it is necessary for the flow control mechanism of the flow controller 1120 to continue to control the flow rate in accordance with the flow control characteristic.

FIG. 12 is a graph showing one example of the flow control characteristic of the flow controller 1120. In FIG. 12, the horizontal axis corresponds to the flow value and the vertical axis corresponds to the flow voltage value. A straight line 1201 shown with a solid line is a flow control characteristic. In the straight line 1201, the flow values from 0 sccm (standard cc per minute) to 200 sccm correspond to the flow voltage values from 0 V to 5 V one on one. For example, when the flow control mechanism of the flow controller 1120 is operated in accordance with the flow control characteristic of the straight line 1201, if the flow monitoring unit 1111 transmits the requested value at 2.5 V, as shown with a dotted arrow 1202 in FIG. 12, the flow value is 100 sccm.

However, when the flow control characteristic of the flow control mechanism fluctuates due to a temporal change, problems mentioned below occur. For example, as shown with a dashed straight line 1203 in FIG. 12, when offset 1205 is generated to the flow control characteristic due to zero-point shift of the flow control mechanism, if the flow monitoring unit 1111 transmits the requested value at 2.5 V, as shown with a dashed dotted line arrow 1204 in FIG. 12, the actual flow value becomes Y sccm, which is different from 100 sccm. At this time, since the flow control mechanism is in the flow control state whose flow voltage value corresponds to 2.5 V, the flow controller 1120 transmits 2.5 V as a return value. In this case, when the flow monitoring unit 1111 converts the return value into the flow value in accordance with the pre-registered flow control characteristic (the straight line 1201 shown in FIG. 12), the flow value becomes 100 sccm. In other words, even though the actual flow rate in the flow controller 1120 is Y sccm, which is different from 100 sccm, the flow monitoring unit 1111 happens to recognize the flow value as the flow rate at the 100 sccm as requested. In this case, the flow monitoring unit 1111 cannot detect the flow abnormality.

In order to avoid this problem, conventionally, while the substrate treatment apparatus 1110 is in a pause, the zero point is adjusted so as to match the flow control characteristic of the flow control mechanism with the flow control characteristic registered in the flow monitoring unit 1111. However, when nonconformity between the flow control characteristic of the flow control mechanism and the flow control characteristic registered in the flow monitoring unit 1111 is discovered while the substrate treatment apparatus 1110 is in a pause, a substrate treatment(s) implemented in the state where a normal flow control is not conducted is included in the substrate treatments implemented by the substrate treatment apparatus 1110 up to a given time. Consequently, in the method where the zero point is adjusted while the substrate treatment apparatus 1110 is in a pause, the substrate treatment in the abnormal flow control state cannot be certainly prevented.

Further, in a recent miniaturization process or sheet-feed process where a process margin of flow rate becomes extremely narrowed, if the substrate treatment is implemented in the abnormal flow control state, a production yield shall be greatly decreased.

The present invention is for resolving the conventional problems, and its objective is to provide a monitoring method and a monitoring apparatus where abnormality in a device that controls a fluid throughput can be certainly detected.

In order to accomplish the objective, the present invention has adopted technical means mentioned below. At first, the present invention is premised upon a monitoring method for a device having a mechanism that controls a throughput of a fluid to be supplied to a substrate treatment apparatus or a fluid to be discharged from the substrate treatment apparatus. The device controls the throughput to be a throughput according to a control signal pre-corresponding to a control state of the throughput control mechanism when the control signal is entered. Also, the device transmits an electric signal indicating the control state of the throughput control mechanism as an output value. Then, in the monitoring method relating to the present invention, a first output value corresponding to a reference state of the throughput control mechanism is acquired before the start of a substrate treatment by the substrate treatment apparatus. Herein, the reference state is the control state of the throughput control mechanism when no control signal is entered. Next, a second output value corresponding to the control state of the throughput control mechanism during the control of the throughput according to the control signal is acquired in the substrate treatment. Further, a difference between the first output value and the second output value is calculated as an output difference value. Then, whether or not the throughput control is abnormal is determined based upon the calculated output difference value. For example, the device having the throughput control mechanism is a flow controller that adjusts a flow rate of a liquid or gas to a predetermined flow rate or a pressure controller that adjusts a pressure within the substrate treatment apparatus by adjusting the degree of opening of a pressure control valve.

According to this configuration, whether or not the device having the throughput control mechanism can be certainly detected. When the monitoring method is adopted, it prevents the continuous implementation of a substrate treatment under a condition where the throughput abnormality has occurred. For example, in case that the device having the throughput control mechanism is the flow controller, the reference state is the control state with zero flow, and the output difference value corresponds to an actual flow rate. Further, in case that the device having the throughput control mechanism is the pressure controller, the reference state is the control state when the inside of the substrate treatment apparatus has reached a predetermined pressure according to the control signal, and the output difference value corresponds to a fluctuation amount of the pressure control valve. Furthermore, when multiple times of same throughput controls are implemented, whether or not the throughput control is abnormal is determined per throughput control based upon the output difference value calculated for each throughput control.

Further, in the monitoring method, a difference between the output difference value calculated with regard to the throughput control which is subject for abnormality determination and the output difference value calculated with regard to other throughput control completed before the throughput control to be determined is calculated, and whether or not the throughput control is abnormal may be detected by comparing between the calculated difference of the output difference values and a pre-set specification value. With this method, whether or not the control characteristic of the throughput control mechanism fluctuates and whether or not the control accuracy is abnormal can be detected. In addition, with this configuration, the specification value, which is a determination criterion for abnormality detection, can be set independently from a set value (a control signal level) of the throughput. Consequently, it is unnecessary to change the specification value according to the set value of the throughput and the throughput can be more strictly managed. Further, it is preferable that the other throughput control is the throughput control completed immediately before the throughput control, which is subject for abnormality detection. In this case, the occurrence of the control characteristic fluctuation can be further detected.

In addition, it is preferable in the monitoring method that the difference between the output difference values is accumulated throughout the multiple times of throughput controls implemented within a predetermined period, and whether or not the throughput control is abnormal is determined based upon the accumulated value. With this method, a trend of long-term fluctuation in the control characteristic can be recognized and the occurrence of the throughput control abnormality can be predicted.

In the meantime, in another viewpoint, the present invention can also provide a monitoring apparatus for a device having a mechanism that controls a throughput of a fluid to be supplied to the substrate treatment apparatus or a fluid to be discharged from the substrate treatment apparatus. The device controls the throughput to be a throughput according to a control signal pre-corresponding to a control state of the throughput control mechanism when the control signal is entered. Also, the device transmits an electric signal indicating the control state of the throughput control mechanism as an output value. Then, the monitoring apparatus relating to the present invention is equipped with an input port, an operation unit and a determination unit. The input port acquires the output value. The operation unit calculates an output difference value, which is a difference between the output value corresponding to a reference state of the throughput control mechanism acquired before the start of the substrate treatment by the substrate treatment apparatus and the output value corresponding to the control state of the throughput control mechanism acquired during the throughput control according to the control signal in the substrate treatment. Then, the determination unit determines whether or not the device is abnormal based upon the output difference value.

It is preferable that the operation unit is configured to further calculate a difference between the output difference value calculated with regard to the throughput control, which is subject for abnormal determination, and the output difference value calculated with regard to other throughput control completed before the throughput control to be determined. In this case, the determination unit determines whether or not the throughput control is abnormal by comparing between the calculated difference of the output difference values and a pre-set specification value. It is preferable that the other throughput control is a throughput control completed immediately before the throughput control which is subject for abnormal determination.

Further, the determination unit can be configured to accumulate the difference of the output difference values throughout the multiple times of throughput controls implemented within a predetermined period, and to determine whether or not the throughput control is abnormal based upon the accumulated value.

In addition, the monitoring apparatus may be further equipped with a zero point correction unit of the output value, based upon the determination result after each determination by the determination unit.

According to the present invention, the supply abnormality or the discharge abnormality of a fluid can be certainly detected per substrate treatment implemented by the substrate treatment apparatus. Further, whether or not the control characteristic of the mechanism that controls the throughput of a fluid fluctuates, the abnormality of the control accuracy and the occurrence of the control characteristic fluctuation can also be detected. In addition, the supply abnormality or the discharge abnormality of a fluid caused by gradual fluctuation of the control characteristic, which is difficult to be detected per substrate treatment, can be certainly detected.

Further, according to the present invention, the determination criterion for determining the presence of abnormality can be set independently from a throughput of a fluid; concurrently, the supply abnormality or the discharge abnormality of a fluid can be strictly monitored.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram showing a monitoring apparatus in the first embodiment according to the present invention.

FIG. 2 is a schematic graph showing one example of a return value transmitted by the flow controller in the first embodiment according to the present invention.

FIG. 3 is a graph showing one example of flow control characteristic in the first embodiment according to the present invention.

FIG. 4 is a schematic graph for explaining a principle of a zero point level shift and a flow control accuracy implemented by the operation unit in the first embodiment according to the present invention.

FIG. 5 is a schematic graph for explaining a monitoring principle of long-term fluctuation implemented by the operation unit in the first embodiment according to the present invention.

FIG. 6 is a flowchart showing the monitoring apparatus in the first embodiment according to the present invention.

FIGS. 7A and 7B are schematic graphs showing a difference between the specification range in the first embodiment according to the present invention and the conventional specification range.

FIG. 8 is a schematic configuration diagram showing a monitoring apparatus in the second embodiment according to the present invention.

FIG. 9 is a schematic configuration diagram showing a monitoring apparatus in the third embodiment according to the present invention.

FIGS. 10A and 10B are schematic graphs showing a relationship between the external leakage amount in the treatment chamber and an operation value of a pressure control valve, and between the external leakage amount and a fluctuation amount of the pressure control valve in the third embodiment according to the present invention, respectively.

FIG. 11 is a schematic diagram for explaining a conventional monitoring method.

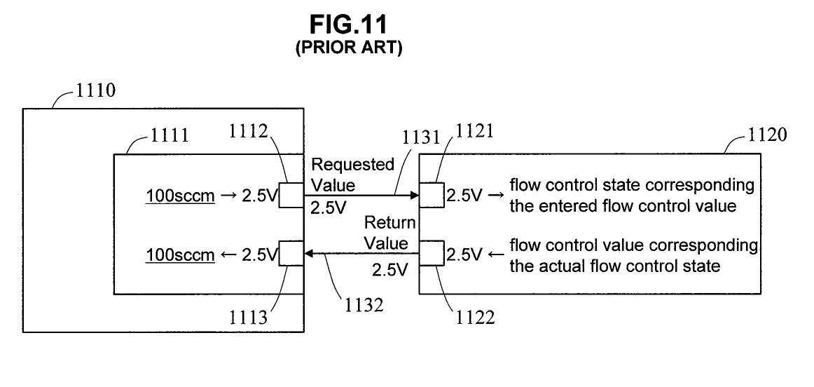

FIG. 12 is a graph showing one example of the flow control characteristic in the conventional monitoring method.

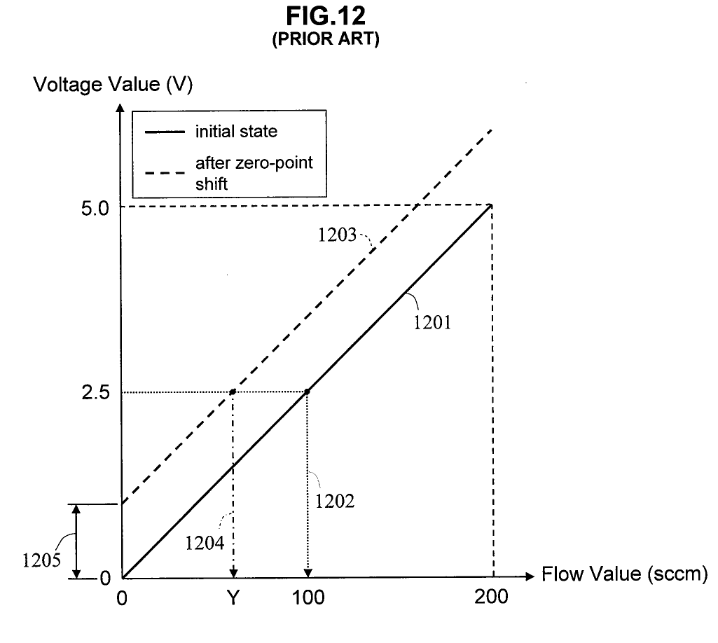

### DETAILED DESCRIPTION OF PREFERRED EMBODIMENTS

### First Embodiment

Hereafter, the first embodiment of the present invention will be described with reference to the drawings. In this embodiment, the present invention is embodied according to a case for monitoring a flow controller that is used in conjunction with a substrate treatment apparatus is monitored.

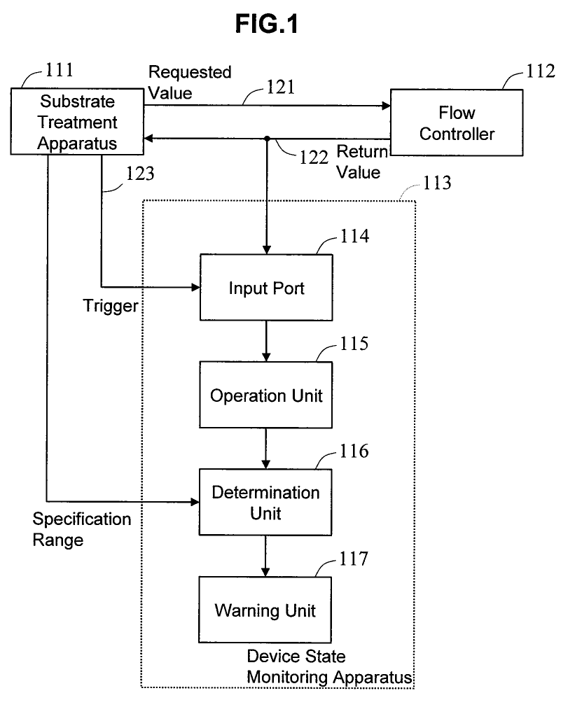

FIG. 1 is a schematic configuration diagram showing a monitoring apparatus of this embodiment. As shown in FIG. 1, in this embodiment, a monitoring apparatus 113 is configured as a separate body from a substrate treatment apparatus 111. In this embodiment, as similar to the prior art the substrate treatment apparatus 111 transmits a requested value 121 (a control signal) to a flow controller 112 on the occasion of a substrate treatment. The flow controller 112 controls a flow rate of a fluid to be supplied to the substrate treatment apparatus 111 according to the requested value 112, and a flow control state of a flow control mechanism is transmitted to the substrate treatment apparatus 111 as a return value 122 (an output value). Furthermore, in this embodiment, the requested value 121 and the return value 122 are regarded as flow voltage values. Further, the substrate treatment apparatus 111 of this embodiment is an apparatus that introduces a constant flow rate of a process gas into a treatment chamber and conducts etching or forms a film to a subject to be treated contained within the treatment chamber.

The monitoring apparatus 113 of this embodiment is equipped with an input port 114, an operation unit 115 and a determination unit 116. The input port 114 acquires the return value 122 entered from the flow controller 112 to the substrate treatment apparatus 111 according to a trigger signal 123 transmitted from the substrate treatment apparatus 111. In this embodiment, the substrate treatment apparatus 111 transmits a zero point acquiring trigger before a predetermined time for transmitting the requested value 121. Further, the substrate treatment apparatus 111 transmits a data acquiring trigger at a constant cycle during the period until the substrate treatment is completed after the requested value is transmitted.

The operation unit 115 conducts various calculations described below based upon the return value 122 acquired by the input port 114. The determination unit 116 determines whether or not the flow control is abnormal based upon a calculation result of the operation unit 115. In this embodiment, it is configured such that the substrate treatment apparatus 111 maintains a specification range (a specification value) of the return value 122 corresponding to the requested value 121, and the determination unit 116 acquires the specification range as a determination criterion. For example, the operation unit 115 and the determination unit 116 can be realized by an exclusive-use calculation circuit, or hardware having a processor and memories such as RAM (random access memory) or ROM (read only memory), etc. and software stored in the memories and operating on the processor.

In the monitoring apparatus 113, the operation unit 115 calculates an actual flow rate, a difference between the calculated actual flow rate and other actual flow rate calculated with regard to a substrate treatment implemented immediately before the substrate treatment, and a total of the differences calculated with regard to the substrate treatments implemented after the reference substrate treatment. Hereafter, each calculation will be described.

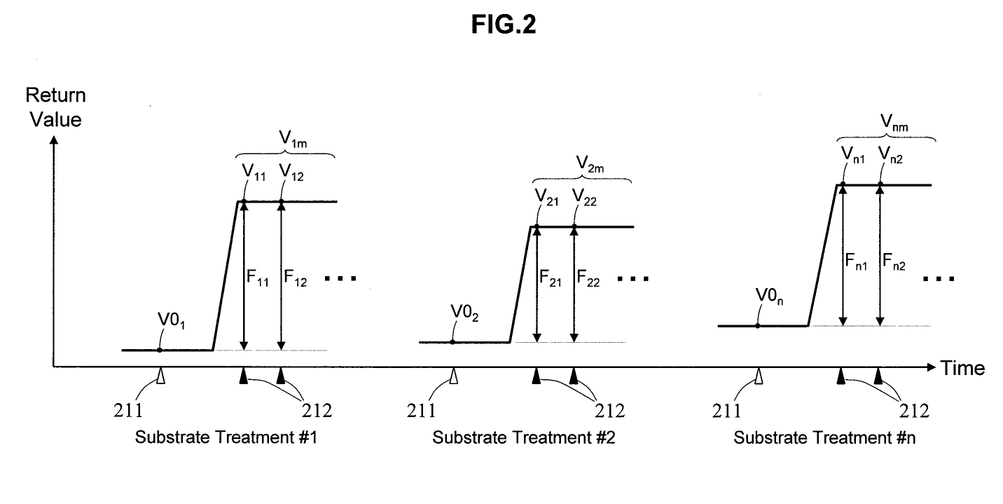

First, the calculation of the actual flow rate will be described. FIG. 2 is a schematic graph showing one example of the return value 122 transmitted by the flow controller 112. In FIG. 2, the horizontal axis corresponds to time and the vertical axis corresponds to the return value 122 (flow voltage value). FIG. 2 shows the return value 122 transmitted from the flow controller 112 throughout multiple times of substrate treatments by the substrate treatment apparatus 111. Also, FIG. 2 shows a state where the requested value 121 is transmitted from the substrate treatment apparatus 111 and the flow controller 112 transmits the return value 122 according to each requested value 121 in each substrate treatment.

When the zero point acquiring trigger 211 is entered from the substrate treatment apparatus 111, the input port 114 acquires the return value 122 at the moment from the flow controller 112. At this time, since the substrate treatment apparatus 111 has not transmitted the requested value 121 to the flow controller 112 yet, the flow controller 112 is in a reference state where no flow control is started. Herein, the reference state is a state where no process gas is supplied to the treatment chamber of the substrate treatment apparatus 111, i.e., a state with zero flow. Hereafter, the return value 122 acquired according to the zero point acquiring trigger 211 is referred to as zero point level V0ₙ (n=1, 2, 3, . . . ; n is a number to specify a treatment order of the substrate treatments by the substrate treatment apparatus 111).

When the data acquiring trigger 212 is entered from the substrate treatment apparatus 111, the input port 114 acquires the return value 122 at the moment from the flow controller 112. At this time, the flow controller 112 is in a state where a flow control is conducted according to the requested value 121 transmitted by the substrate treatment apparatus 111. Furthermore, in FIG. 2, the substrate treatment apparatus 111 transmits a control signal with the output level Vₙ to the flow controller 112 as the requested value 121 in each substrate treatment. In each substrate treatment, the requested value 121 is constant during the substrate treatment. Hereafter, under the state where the requested value 121 is entered, the return value 122 acquired from the flow controller 112 according to the data acquiring trigger 212 is referred to as a flow output level Vₙₘ (m=1, 2, 3 . . . ; m is a number to specify a data acquired order in the substrate treatment #n).

The zero point level V0ₙ and the flow output level Vₙₘ acquired by the input port 114 are entered into the operation unit 115. The operation unit 115 calculates an actual flow rate Fₙₘ from a difference (an output difference value) between the zero point level V0ₙ and the flow output level Vₙₘ using an expression 1 mentioned below. Herein, for the return value 122, it is assumed that the flow voltage values at Vₘᵢₙ to Vₘₐₓ (V) correspond to a flow control range Fₘᵢₙ to Fₘₐₓ (sccm) of the flow controller 112 one on one according to a proportional line.

$${F}_{n m} = \frac{{V}_{n m} - V {0}_{n}}{{V}_{max} - {V}_{min}} \times ( {F}_{max} - {F}_{min} ) \qquad ( 1 )$$

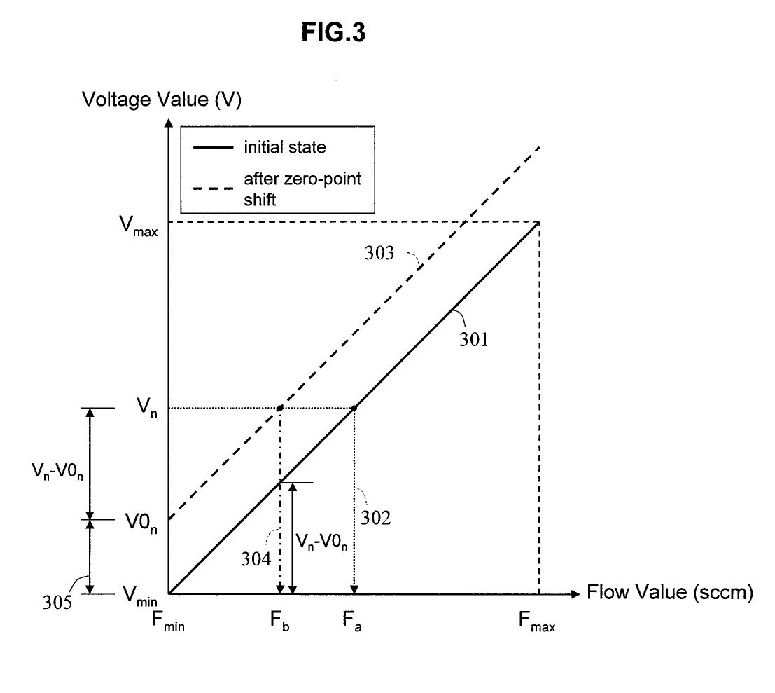

The expression 1 is explained using FIG. 3. FIG. 3 is a graph showing one example of a flow control characteristic of the flow controller 112. In FIG. 3, the horizontal axis corresponds to a flow value and the vertical axis corresponds to a flow voltage value. Herein, a straight line 301 shown with a solid line in FIG. 3 is a flow control characteristic that is pre-registered in the substrate treatment apparatus 111. In the straight line 301, the flow values from Fₘᵢₙ to Fₘₐₓ correspond to the flow voltage values from Vₘᵢₙ to Vₘₐₓ one on one according to the proportional line. For example, when the flow control mechanism of the flow controller 112 operates according to the flow control characteristic shown with the straight line 301, if the substrate treatment apparatus 111 transmits the requested value 121 at Vₙ, as shown with a dotted arrow 302 in FIG. 3, the flow value of the flow controller becomes Fₐ.

Herein, it is assumed that a zero point shift occurs to the flow control characteristic of the flow controller 112 due to a temporal change, and the flow controller 112 operates according to the flow control characteristic of a straight line (a straight line 303 shown with a broken line in FIG. 3) having an offset 305 with regard to the straight line 301. In this case, when the substrate treatment apparatus 111 transmits the requested value 121 at Vₙ, as shown with a dashed-dotted arrow 304, the flow value of the flow controller 112 becomes F_{b}. In this case, according to the expression 1, the actual flow rate Fₙₘ is obtained based upon a difference between the flow output level Vₙₘ and the zero point level V0ₙ immediately before the start of the flow control. Consequently, an influence of the offset 305 shown in FIG. 3 is eliminated and the flow value F_{b} is calculated as the actual flow rate Fₙₘ. In other words, the actual flow rate Fₙₘ accurately indicates an actual flow rate during each substrate treatment implemented by the substrate treatment apparatus 111. Furthermore, the operation unit 115 associates the calculated actual flow rate Fₙₘ with a data specifying a substrate treatment order, a data acquisition order and a period described below, and stores the data in the memory in the operation unit 115.

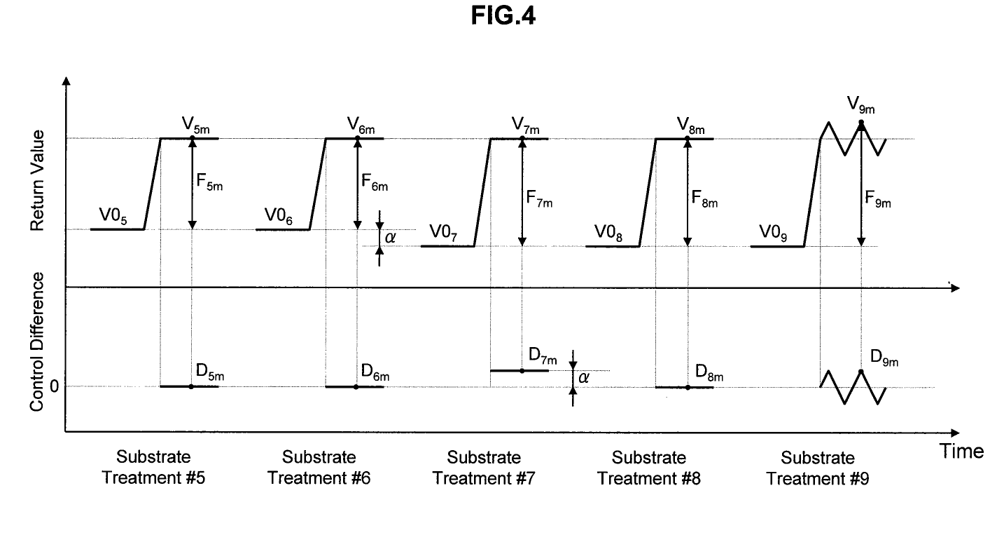

In the meantime, the operation unit 115 conducts the operation for monitoring a zero point level shift and a flow control accuracy based on the actual flow rate Fₙₘ as mentioned below, in addition to the above-mentioned operation. FIG. 4 is a schematic graph for explaining the principle of this monitoring method. In FIG. 4, the horizontal axis corresponds to the time and the vertical axis corresponds to the return value 122 (a flow voltage value). Furthermore, in FIG. 4, the requested value 121 at the same output level Vₙ is entered from the substrate treatment apparatus 111 to the flow controller 112 in each substrate treatment (substrate treatment #5 to substrate treatment #9 in FIG. 4).

When the n-th substrate treatment (substrate treatment #n) is started, the operation unit 115 calculates an average actual flow rate AFₙ₋₁, which is an average value of all actual values F₍ₙ₋₁₎ₘ calculated with the expression 1 in the last substrate treatment #n−1. Then, a control difference Dₙₘ, which is a difference between the actual flow rate Fₙₘ calculated using the expression 1 in the currently-implemented substrate treatment #n and the average actual flow rate AFₙ₋₁, is operated using the following expression 2:

$${D}_{n m} = {F}_{n m} - {AF}_{n - 1} = {F}_{n m} - \frac{1}{m} {\sum }_{k = 1}^{m} {F}_{( n - 1 ) k} \qquad ( 2 )$$

In the substrate treatment #n, which is currently implemented, and the substrate treatment #n−1, which has been completed immediately before the substrate treatment #n; in case that the flow controller 112 conducts the same flow control, the control difference Dₙₘ calculated using the expression 2 becomes substantially zero (substrate treatments #5, #6 and #8 shown in FIG. 4). In the meantime, in case that the flow controller 112 does not conduct the same flow control, the control difference Dₙₘ indicates a value other than zero (substrate treatments #7 and #9 shown in FIG. 4).

As shown in FIG. 4, when the control difference Dₙₘ is a value other than zero, there are a case that the control difference Dₙₘ indicates substantially a constant value throughout the entire period when the data acquiring triggers 212 are entered (substrate treatment #7 shown in FIG. 4) and another case that the control difference Dₙₘ fluctuates during the period when the data acquiring triggers 212 are entered (substrate treatment #9 shown in FIG. 4). The state where the control difference Dₙₘ indicates substantially a constant value throughout the entire period when the data acquiring triggers 212 are entered is a state where even though the return value 122 is a value according to the requested value 121, the actual flow rate is different from the return value 122. In other words, it indicates the state where an offset occurs to the flow control characteristic of the flow controller 112. Further, the state where the control difference Dₙₘ fluctuates during the period when the data acquiring triggers 212 are entered indicates a state where the actual flow rate is unstable. Especially, when control difference Dₙₘ fluctuates around zero, no offset occurs to the flow control characteristic at the time of the last substrate treatment; however, it indicates a state where the actual flow rate fluctuates. Therefore, the shift of the zero point level and the deterioration of the flow control accuracy can be detected monitoring the control difference Dₙₘ. Furthermore, the operation unit 115 associates the calculated control difference Dₙₘ with a data specifying a substrate treatment order, a data acquisition order and a period described below, and stores the data in the memory in the operation unit 115.

Further, in this embodiment, the operation unit 115 calculates an average control difference ADₙ shown in the expression 3 mentioned below. Herein, the average control difference ADₙ is a difference between the average actual flow rate AFₙ calculated using the actual flow rate Fₙₘ for currently-implemented substrate treatment #n and the average actual flow rate AFₙ₋₁ calculated using the actual flow rate F₍ₙ₋₁₎ₘ for the last substrate treatment #n−1.

$${AD}_{n} = {AF}_{n} - {AF}_{n - 1} = \frac{1}{m} {\sum }_{k = 1}^{m} {F}_{nk} - \frac{1}{m} {\sum }_{k = 1}^{m} {F}_{( n - 1 ) k} \qquad ( 3 )$$

As described above, in this embodiment the shift of the zero point level and the deterioration of the flow control accuracy are detected according to the control difference Dₙₘ; however, the similar detection can be conducted using the average control difference ADₙ calculated using the expression 3. In case that the control difference Dₙₘ is used, because the actual flow rate Fₙₘ calculated for the currently-implemented substrate treatment #n is directly used, the flow control abnormality can be detected with the maximum detection sensitivity. In the meantime, in case that the average control difference ADₙ is used, because subtle fluctuation such as noise can be eliminated by using the average actual flow rate AFₙ, thus only crucial control abnormality can be detected. Furthermore, in this embodiment, when n=1, the operation unit 115 sets the values of the control difference D₁ₘ and the average control difference AD₁ at zero.

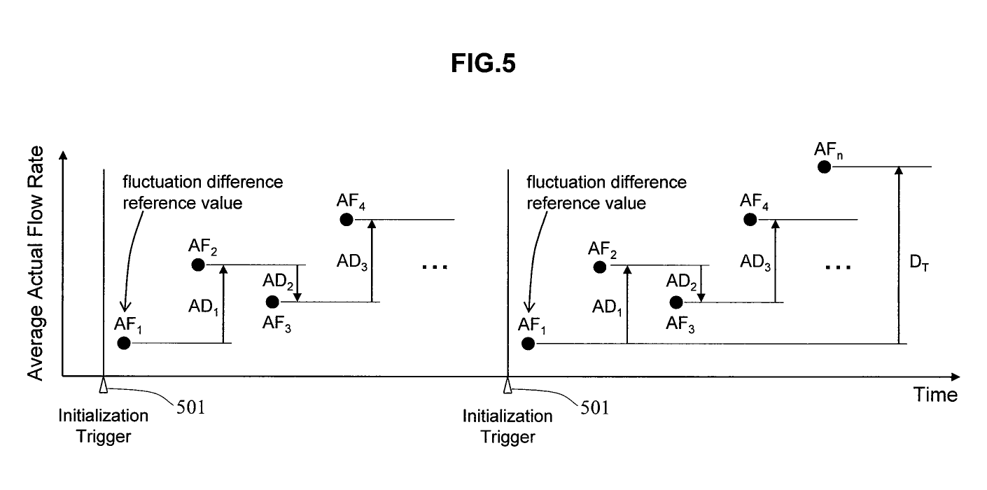

Further, the operation unit 115 conducts the operation for monitoring long-term fluctuation using the actual flow rate Fₙₘ in addition to the above-mentioned operation. FIG. 5 is a schematic graph for explaining the principle of this monitoring method. In FIG. 5, the horizontal axis corresponds to the time and the vertical axis corresponds to the average actual flow rate AFₙ. The points shown in FIG. 5 indicate the average actual flow rate AFₙ calculated for each substrate treatment, and a difference between the adjacent two points indicates the average control difference ADₙ calculated using the expression 3. Then, the operation unit 115 calculates a fluctuation difference D_{T} using an expression 4 mentioned below.

$${D}_{T} = {\sum }_{k = 1}^{n} {AD}_{k} \qquad ( 4 )$$

The calculation of the fluctuation difference D_{T} is implemented every time a substrate treatment is completed within the pre-determined period, such as every day, every maintenance or every predetermined-lot number. The fluctuation difference D_{T} indicates a fluctuation amount from the initial state when a specific substrate treatment is regarded as the initial state (fluctuation difference reference value). In this embodiment, the number n that specifies a treatment order of the substrate treatments according to an initialization trigger 501, which is entered at first during the above-mentioned period from the substrate treatment apparatus 111, is reset. Then, after the entry of the initialization trigger 501, a substrate treatment that is implemented first by the substrate treatment apparatus 111 is recognized as the substrate treatment #1. Therefore, the fluctuation difference D_{T} calculated from the expression 4 indicates the fluctuation amount from the fluctuation difference reference value at the time of completion of substrate treatment #n.

When the fluctuation difference D_{T} is a value other than zero, the flow control characteristic of the flow controller 112 fluctuates from the initial state (at the time of entering the initialization trigger 501). Therefore, the long-term fluctuation trend of the flow control characteristic can be recognized according to the fluctuation difference D_{T}. For example, even if the fluctuation of the flow control characteristic in each substrate treatment is minute, an accumulated amount of the fluctuation can be recognized. In other words, the flow control abnormality caused by a gradual fluctuation of the control characteristic, which is difficult to be detected per substrate treatment, can be detected.

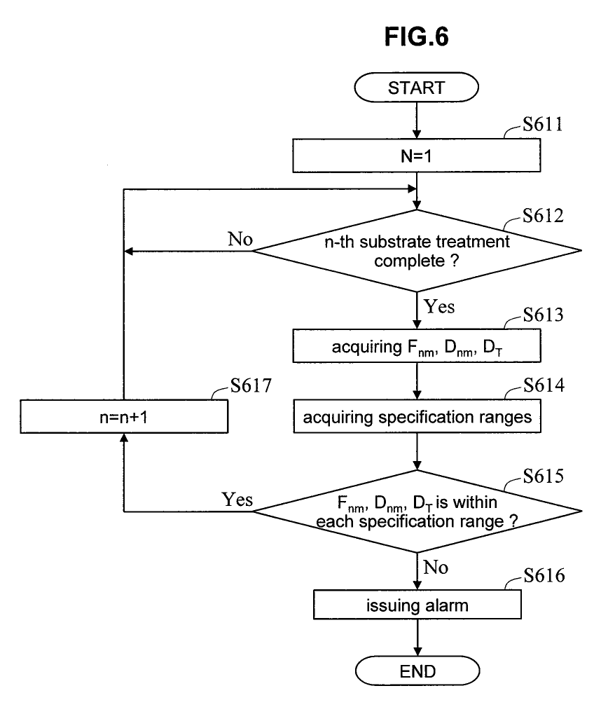

The determination unit 116 determines whether or not the flow controller 112 is abnormal based upon the actual amount Fₙₘ, the control difference Dₙₘ (or the average control difference ADₙ) and the fluctuation difference D_{T} calculated by the operation unit 115 as described above. FIG. 6 is a flowchart showing the device state monitoring process implemented by the determination unit 116. Herein, the monitoring process is started by the substrate treatment apparatus 111 before the first substrate treatment during each period is implemented.

When the device state monitoring process is started, the determination unit 116 stands by until the substrate treatment #n is completed (Steps S611, S612 No). Then, when the substrate treatment #n is completed, the determination unit 116 acquires the actual flow rate Fₙₘ, the control difference Dₙₘ and the fluctuation difference D_{T} from the operation unit 115 (Steps S612 Yes, S613). At this time, for the actual flow rate Fₙₘ and the control difference Dₙₘ, the determination unit 116 acquires all of the actual flow rates Fₙₘ and all of the control differences Dₙₘ calculated during the substrate treatment #n from the operation unit 115.

Next, the determination unit 116 acquires specification ranges (specification values) of the actual flow rate Fₙₘ, the control difference Dₙₘ and the fluctuation difference D_{T} (Step S614). The determination unit 116 compares the acquired specification range to the actual flow rate Fₙₘ, the control difference Dₙₘ and the fluctuation difference D_{T}, respectively, and determines whether or not each value is within the specification range (Step S615). In this embodiment, as the specification range of the actual flow rate Fₙₘ, an upper limit value and a lower limit value are set. According to the upper limit value and the lower limit value, a range of the actual flow rate, which is allowed as a flow value according to the requested value 121 transmitted by the substrate treatment apparatus 111, is set. Further, as the specification range of the control difference Dₙₘ, an upper limit value and a lower limit value are set. According to the upper limit value and the lower limit value, a range of the flow control accuracy, which is allowed during the flow control, is set. Furthermore, in this embodiment, although this is not especially limited, the specification range of the fluctuation difference D_{T} is the same as the specification range of the actual flow rate Fₙₘ.

In the determination, the determination unit 116, for example, at first, determines whether or not the control differences Dₙₘ are within the specification range. When the control differences Dₙₘ are not within the specification range, the determination unit 116 confirms a sign of each of the acquired control differences Dₙₘ. Then, when the control differences Dₙₘ contains difference signs, the determination unit 116 determines that the control accuracy is abnormal. Further, when the signs of the control differences Dₙₘ are all the same, the determination unit 116 determines as occurrence of zero point shift. Next, the determination unit 116 determines whether or not the actual flow rates Fₙₘ are within the specification range. When the actual flow rates Fₙₘ are not within the specification range, the determination unit 116 determines that there is an unallowable zero point shift. Next, the determination unit 116 determines whether or not the fluctuation difference D_{T} is within the specification range. When the fluctuation difference D_{T} is not within the specification range, the determination unit 116 also determines that there is an unallowable zero point shift.

When the determination unit 116 determines that there is an abnormality as described above, the determination unit 116 instructs a warning unit 117 to issue an alarm; concurrently, transmits the determination result (Step S615 No, S616). The warning unit 117 that has received the instruction issues an alarm in any form, such as sound, light, warning display or e-mail, which can notify the abnormality to an operator; concurrently, the classification of the abnormality is displayed on a display (not-shown) in the monitoring apparatus 113. Further, on this occasion, the warning unit 117 may be configured to make the substrate treatment apparatus 111 be inoperative. The operator who has recognized the occurrence of abnormality restores each device according to a matter displayed on the display.

Further, when all of the actual flow rates Fₙₘ, the control differences Dₙₘ and the fluctuation difference D_{T} are within the specification ranges, respectively, the determination unit 116 stands by until a next substrate treatment is completed, and performs the above-mentioned determination for the next substrate treatment (Step S615 Yes, S617, S612).

As explained above, according to this embodiment the flow control abnormality, such as the zero point shift or the abnormality of control accuracy, can be certainly detected per substrate treatment implemented by the substrate treatment apparatus 111. Consequently, continuous implementation of the substrate treatments under the condition where abnormality has occurred can be certainly prevented. Further, the flow control abnormality caused by a gradual fluctuation of the control characteristic, which is difficult to be detected per substrate treatment, can also be certainly detected.

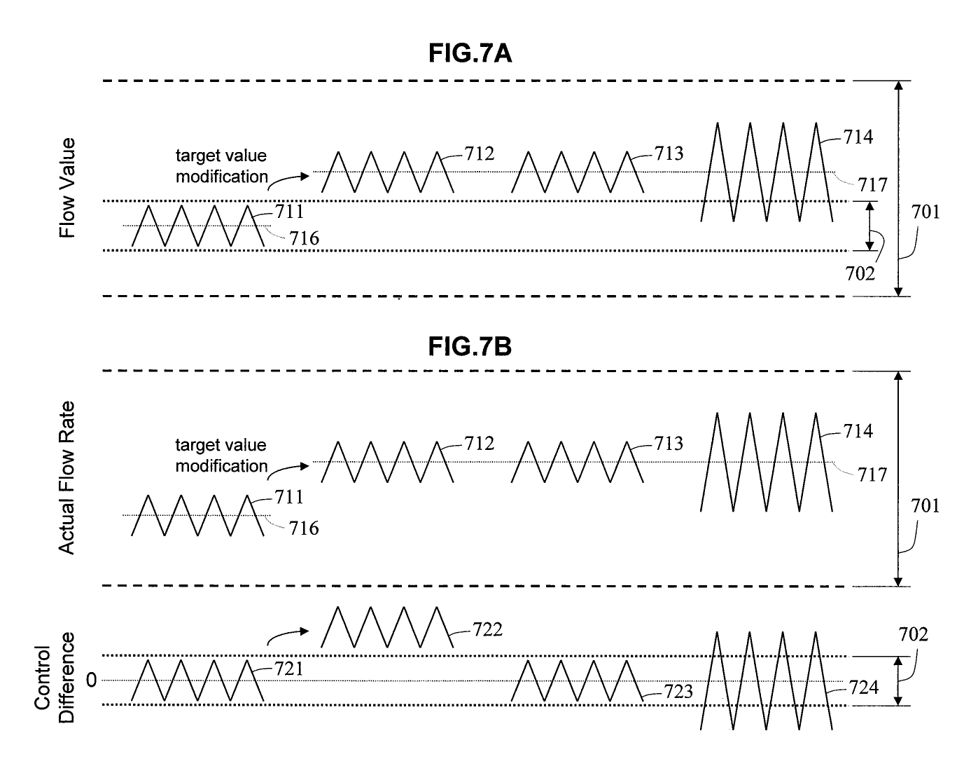

Further, this embodiment also has advantages as mentioned below compared to the prior art. FIGS. 7A and 7B are schematic graphs for explaining a difference between the specification range of this embodiment and the conventional specification range. FIG. 7A shows one example of the conventional specification range, and FIG. 7B shows one example of the specification range of this embodiment. The horizontal axis in FIGS. 7A and 7B corresponds to a time. The vertical axis in FIG. 7A corresponds to a flow value. The vertical axis of the upper stage in FIG. 7B corresponds to the actual flow rate and the vertical axis of the lower stage in FIG. 7B corresponds to the control difference Dₙₘ. Furthermore, FIGS. 7A and 7B show the data acquire with regard to four substrate treatments. Herein, it is assumed that no zero point shift occurs.

Conventionally, as shown in FIG. 7A, a specification range 702 for the flow values is set within a set range 701 of the target value of the flow value. Herein, the set range 701 of the target value means a range where when the state of the substrate treatment apparatus 111 (for example, a state of generated plasma) temporally changes, a modification of the target value is allowed associated with the temporal change in the process applied to a substrate subject for substrate treatment. Further, the specification range 702 of the control accuracy is a range of flow values where fluctuation is allowed in the flow control when a target value is set. In the recent miniaturization process or sheet-feed process, since a process margin of flow rate is extremely narrow, the specification range 702 of the control accuracy is extremely narrow. Consequently, in the conventional monitoring apparatus, when the target value is modified according to the temporal change of the substrate treatment apparatus, it is necessary to modify the specification range 702 of the control accuracy. In FIG. 7A, when the target value of the flow control is modified from a target value 716 equal to the flow value 711 to a target value 717 equal to the flow value 712, the flow value changes according to the modification in the target value. In this case, if the specification range 702 of the control accuracy is not modified, the flow values 712, 713 and 714 in the substrate treatment after the modification of the target value do not satisfy the specification range 702 of the control accuracy shown in FIG. 7A. Therefore, all of them are determined as abnormal. Since the flow value 714 fluctuates exceeding the specification width of the control accuracy, even if it is determined as abnormal, there is no problem. However, since the flow values 712 and 713 are values according to the target values after the modification and they fluctuate within the specification width, the flow control is normally conducted. In other words, the normal flow control is falsely detected as abnormal. In order to prevent the occurrence of false detection, conventionally, every time the target value of the flow value is modified, it is necessary to modify the specification range of the control accuracy. This modification is a very complicated task when multiple types of flow values are set within one substrate treatment or when multiple types of substrate treatments are implemented by the same substrate treatment apparatus. Further, because the abnormality is constantly detected until the modification of the specification range for the control accuracy is completed; a true abnormality (the flow value 714) cannot be detected.

In the meantime, in this embodiment, independently from the set range 701 of the target value as shown in FIG. 7B, the specification range 702 of the flow control accuracy is set as a specification range of the control difference Dₙₘ. In other words, in FIG. 7B, when the target value of the flow control is modified from a target value 716 equal to the flow value 711 to a target value 717 equal to the flow value 712, the flow value changes according to the modification of the target value. On this occasion, since control differences 721 and 723 corresponding to flow values 711 and 713 satisfy the specification range 702, they are determined as normal. Further, since a control difference 724 corresponding to a flow value 714 does not satisfy the specification range 702 of the control accuracy, it is determined as abnormal. Further, in this embodiment, the control difference 722 corresponding to the flow value 712 immediately after the target value is modified is detected as zero point shift However, whether or not this is the true zero point shift can be easily identified by determining whether or not the shift amount is an amount according to the modification of the target value.

Therefore, in this embodiment, even if the target value is modified, it is unnecessary to change the specification range for the control difference Dₙₘ. In other words, the specification range 702 of the flow control accuracy can be permanently secured, and the abnormality 714 of the flow control accuracy can be certainly detected. Therefore, the flow control abnormality can be easily and accurately detected.

As described above, according to this embodiment, the flow control abnormality can be certainly detected per substrate treatment implemented by the substrate treatment apparatus. Further, whether the abnormality is a fluctuation (zero point shift) of the flow control characteristic or an abnormality of the control accuracy can be easily identified. In addition, the flow control abnormality caused by a gradual fluctuation of the control characteristic, which is difficult to be detected per substrate treatment, can also be certainly detected.

Further, according to this embodiment, the specification range for determining whether or not the flow control is abnormal can be set independently from the flow values; concurrently, the flow control abnormality can be strictly managed.

### Second Embodiment

In the first embodiment, the configuration where when the zero point shift is detected, an alarm is issued was described. However, another configuration where when the zero point shift is detected, the zero point of the flow controller is automatically corrected can also be adopted.

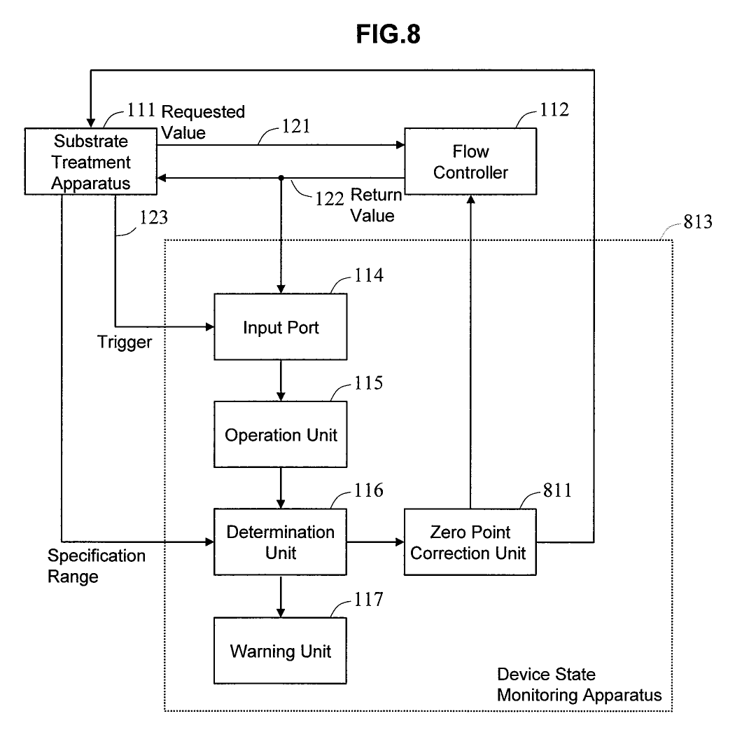

FIG. 8 is a schematic configuration diagram showing a monitoring apparatus of this embodiment. As shown in FIG. 8, a monitoring apparatus 813 of this embodiment is different from the monitoring apparatus 113 explained in the first embodiment in a point of being equipped with a zero point correction unit 811. The other configuration is the same as that of the monitoring apparatus 113. Hereafter, the same components of those in the monitoring apparatus 113 are referred to by the same reference numbers, respectively, and the detailed descriptions will be omitted.

In this embodiment, the zero point correction unit 811 corrects the zero point of the return value based upon a determination result every time the flow control abnormality is determined. Herein, the zero point correction indicates processing where the return value transmitted by the flow controller 112 is corrected to a state with no zero point shift.

According to the technique described in the first embodiment when the determination unit 116 determines as occurrence of the zero point shift the determination unit 116 notifies the zero point correction unit 811 of the occurrence and a shift amount a (see the substrate treatment #7 shown in FIG. 4). The zero point correction unit 811 that has received the notification determines a correction value according to the entered shift amount α. Furthermore, the correction value can be calculated based upon the flow control characteristic, for example, as shown in FIG. 3.

The zero point correction unit 811 that has calculated the correction value notifies the correction value to the flow controller 112, and corrects the zero point of the return value transmitted by the flow controller 112. Further, the zero point correction unit 811 may correct the zero point by notifying the correction value to the substrate treatment apparatus 111 instead of the flow controller 112. In this case, the substrate treatment apparatus 111 offsets the requested value 121 by adding the entered correction value to the requested value 121. This results in the relative correction of the zero point of the return value of the flow controller 112.

According to this embodiment, the zero point correction can be automatically implemented per substrate treatment even to a substrate treatment apparatus where the zero point shift frequently occurs. As a result, an actual flow rate per substrate treatment can be accurately controlled. Further, compared to the first embodiment, the annunciation frequency of the alarm can be reduced, and an operation rate of the substrate treatment apparatus 111 can also be improved.

Furthermore, the monitoring apparatus 813 of this embodiment is also configured such that when the determination unit 116 detects the flow control abnormality, the warning unit 117 issues an alarm. However, when the zero point shift occurs, because the zero point is automatically corrected by the time when a next substrate treatment is implemented, no alarm is issued for the occurrence of zero point shift.

### Third Embodiment

In the first and second embodiments, the cases where the device state of the flow controller is monitored were described. However, the present invention is also applicable to monitoring of a device state of a pressure controller that adjusts pressure within a substrate treatment apparatus by adjusting the degree of opening of a pressure control valve. Then, in the third embodiment, a case where the operation of the pressure controller used integrally with the substrate treatment apparatus will be described.

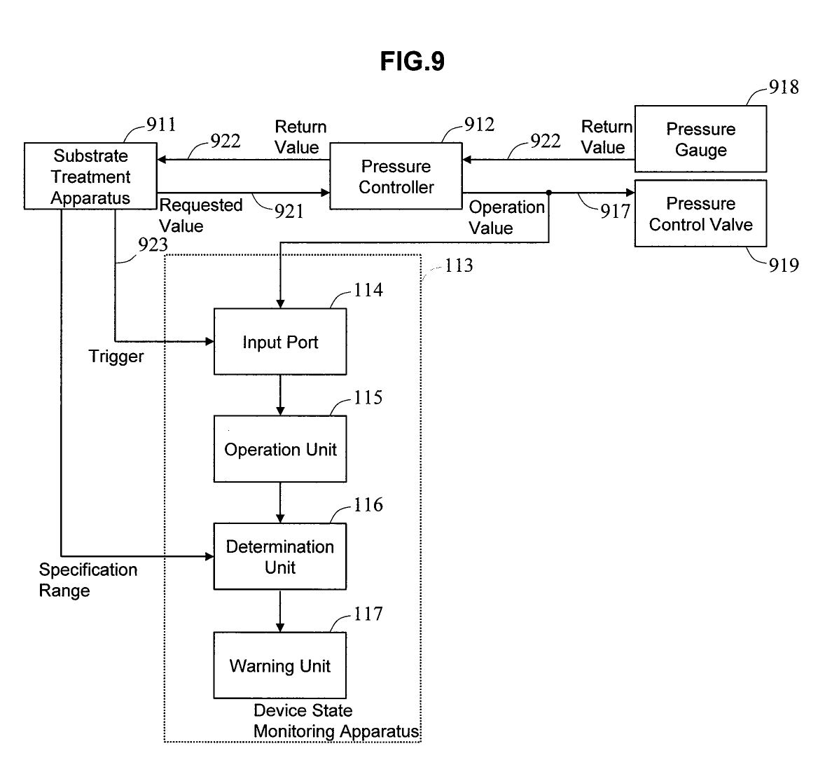

FIG. 9 is a schematic configuration diagram showing the monitoring apparatus of this embodiment. As shown in FIG. 9, in this embodiment, a substrate treatment apparatus 911 transmits a requested value 921 (a control signal) to a pressure controller 912 on the occasion of implementing a substrate treatment, as well, as similar to the first and second embodiments. The pressure controller 912 acquires a return value 922 transmitted from a pressure gauge 918 that measures, for example, pressure within a treatment chamber of the substrate treatment apparatus 911. Here, the return value 922 is a voltage value corresponding to the pressure measured by the pressure gauge 918. The pressure controller 912 enters an operation value 917 (an output value) to the pressure control valve 919 so as to match the pressure value indicated with the return value 922 with a pressure value corresponding to the requested value 921. Herein, the operation value 917 is an electric signal that designates the degree of opening of the pressure control valve 919. Further, the pressure controller 912 sequentially transmits the return value 922 acquired from the pressure gauge 918 to the substrate treatment apparatus 911.

The monitoring apparatus 113 in this embodiment has the same configuration as that of the monitoring apparatus described in the first embodiment. In this embodiment the input port 114 acquires the operation value 917 transmitted from the pressure controller 912 according to a trigger signal 923 transmitted from the substrate treatment apparatus 911.

In this embodiment, when the return value 922 from the pressure controller 912 becomes a value corresponding to the requested value 921 (in a reference state), the substrate treatment apparatus 911 transmits a zero point acquiring trigger. Further, the substrate treatment apparatus 911 transmits the data acquiring trigger at a constant cycle until the treatment is completed after the zero point acquiring trigger is transmitted. Therefore, in this embodiment, the operation value 917 acquired by the input port 114 on the occasion of entering the zero point acquiring trigger is the operation value 917 transmitted from the pressure controller 912 to the pressure control valve 919 at the time of staring the predetermined pressure control. Further, the operation value 917 to be acquired by the input port 114 on the occasion of entering the data acquiring trigger is the operation value 917 transmitted to the pressure control valve 919 while the pressure controller 912 implements the predetermined pressure control. Then, in this embodiment, the operation unit 115 calculates a difference (an output difference value) between the operation value 917 transmitted from the pressure controller 912 to the pressure control valve 919 during the predetermined pressure control and the operation value 917 transmitted from the pressure controller 912 to the pressure control valve 919 in the reference state. In this case, the difference is a value corresponding to a fluctuation amount of the pressure control valve 919.

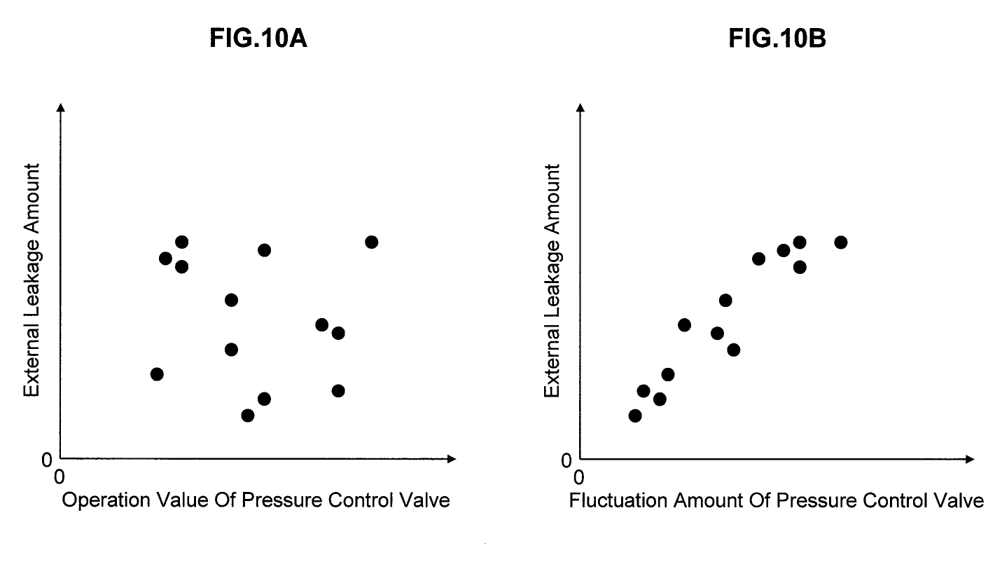

FIGS. 10A and 10B are schematic graphs showing a relationship of an external leakage amount of the treatment chamber, the operation value 917 of the pressure control valve 919 and a fluctuation amount of the pressure control valve 919 in the case that the pressure controller 912 maintains the constant pressure within the treatment chamber. FIG. 10A is a schematic graph showing a relationship between the external leakage amount of the treatment chamber and the operation value 917 of the pressure control valve 919, and FIG. 10B is a schematic graph showing a relationship between the external leakage amount of the treatment chamber and the fluctuation amount of the pressure control valve 919.

As shown in FIG. 10A, when it is operated to maintain the constant pressure within the treatment chamber, no clear correlation between the operation value 917 of the pressure control valve 919 and the external leakage amount can be confirmed. In the meantime, as shown in FIG. 10B, a clear correlation between the fluctuation amount of the pressure control valve 919 and the external leakage amount can be confirmed. This is caused by a modification in the operation value 917 of the pressure control valve 919 according to the return value 921 to be entered from the pressure gauge 918.

Although a discharge capability of a discharge system for the treatment chamber is not always constant, it temporally changes. Consequently, the operation values 917 of the pressure control valve 919 are different from each other in the state where the inside of the treatment chamber is maintained at the same pressure, even under the state where no external leakage exists in the treatment chamber. When the external leakage occurs to the treatment chamber, since an amount corresponding to the external leakage is merely added to the operation value 917, any correlation does not occur between the external leakage amount and the operation value 917 of the pressure control valve 919. In the meantime, under the state where no external leakage exists in the treatment chamber, the fluctuation amount of the pressure control valve 919 becomes substantially zero in the state where the inside of the treatment chamber is maintained at the same pressure. This is because the discharge capacity of the discharge system does not greatly fluctuate during one substrate treatment. Therefore, when the external leakage occurs to the treatment chamber, an amount corresponding to the external leakage is added to the fluctuation amount. As a result, a correlation shall be generated between the external leakage amount and the fluctuation amount of the pressure control valve 919.

Therefore, whether or not the external leakage exists can be determined according to the fluctuation amount of the pressure control valve 919 calculated using the expression 1. Further, if a specification range is set to the fluctuation amount, it also becomes possible to detect the external leakage exceeding a predetermined leakage amount as abnormal.

As described above, according to this embodiment, whether or not the external leakage exists in the treatment chamber, which could not be conventionally detected, can be determined during the substrate treatment and per substrate treatment.

As described above, according to the present invention, the fluid supply abnormality or the discharge abnormality can be certainly detected per substrate treatment implemented by the substrate treatment apparatus. Further, whether or not the control characteristic of the mechanism that controls a throughput of a fluid fluctuates or the abnormality of control accuracy and the occurrence of the control characteristic fluctuation can also be detected. In addition, the supply abnormality or the discharge abnormality of a fluid caused by a gradual fluctuation of the control characteristic, which is difficult to be detected per substrate treatment, can be certainly detected.

Further, according to the present invention, the determination criterion for determining an abnormality can be set independently from an absolute value of the throughput of a fluid; concurrently, the supply abnormality or the discharge abnormality of a fluid can be strictly managed.

Furthermore, the present invention shall not be limited to the above-described embodiments, and they are variously modifiable and applicable without departing from the technical concept of the present invention. For example, in each of the embodiments, it is configured such that the input port acquires the return value and the operation value based upon the trigger signal entered from the substrate treatment apparatus; however, it may be configured such that the input port always acquires the return value and the operation value and calculates an output difference value, a control difference and a fluctuation difference. Further, in the above-mentioned embodiments, the cases where the flow value and the pressure value are controlled at a constant value within one substrate treatment are described. However, a similar efficacy can be obtained even in the case that they are controlled at multiple flow values and multiple pressure values within one substrate treatment, respectively. In this case, the specification range may be individually set with regard to each flow value (each pressure value). In addition, in the above-mentioned embodiments, the configuration where a difference of the output difference values is calculated based upon the output difference value calculated for the throughput control, which was completed immediately before the throughput control that is subject for abnormality determination, is described. However, from the viewpoint to detect the zero point shift and the accuracy of the throughput control, a difference of the output difference values may be calculated based upon not only the last completed throughput control, but also based upon an output difference value calculated with regard to another throughput control, which is completed before the throughput control that is subject for abnormality determination.

With the present invention, an abnormality of a device that controls a throughput of a fluid used in conjunction with a substrate treatment apparatus can be certainly detected per substrate treatment, and the present invention is useful as a monitoring method and a monitoring apparatus for semiconductor production equipment.

What is claimed is:

1. A monitoring method for a device having a mechanism that controls a throughput of a fluid to be supplied to a substrate treatment apparatus or a fluid to be discharged from the substrate treatment apparatus, controlling the throughput to be a throughput according to a control signal pre-corresponding to a control state of the throughput control mechanism when the control signal is entered and transmitting an electric signal indicating the control state of the throughput control mechanism as an output value, comprising the steps of:
acquiring a first output value corresponding to a reference state of the throughput control mechanism before the start of a substrate treatment by the substrate treatment apparatus;
acquiring a second output value corresponding to the control state of the throughput control mechanism during the throughput control according to the control signal in the substrate treatment;
calculating a difference between the first output value and the second output value as an output difference value; and
determining whether or not the throughput control is abnormal based upon the output difference value.

2. The monitoring method according to claim 1, wherein when multiple times of same throughput controls are implemented, whether or not the throughput control is abnormal is determined per throughput control based upon the output difference value calculated for each throughput control.

3. The monitoring method according to claim 2 further comprising a step of calculating a difference between the output difference value calculated with regard to the throughput control that is subject for abnormal determination and the output difference value calculated with regard to other throughput control completed before the throughput control to be determined, wherein whether or not the throughput control is abnormal is determined by comparing between the calculated difference of the output difference values and a pre-set specification value.

4. The monitoring method according to claim 3, wherein the other throughput control is the throughput control completed immediately before the throughput control that is subject for abnormal determination.

5. The monitoring method according to claim 4, wherein the difference of the output difference values are accumulated throughout multiple times of throughput controls implemented within a predetermined period, and whether or not the throughput control is abnormal is determined based upon the accumulated value.

6. The monitoring method according to claim 1, wherein the device having the throughput control mechanism is a flow controller that adjusts a flow rate of a liquid or gas to a predetermined value, and the reference state is the control state with zero flow.

7. The monitoring method according to claim 2, wherein the device having the throughput control mechanism is a flow controller that adjusts a flow rate of a liquid or gas to a predetermined value, and the reference state is a control state with zero flow.

8. The monitoring method according to claim 1, wherein the device having the throughput control mechanism is a pressure controller that adjusts a pressure within the substrate treatment apparatus to a predetermined pressure, and the reference state is the control state at the time when the inside of the substrate treatment apparatus reaches the predetermined pressure according to the control signal.

9. The monitoring method according to claim 2, wherein the device having the throughput control mechanism is a pressure controller that adjusts a pressure within the substrate treatment apparatus to a predetermined pressure, and the reference state is a control state at the time when the inside of the substrate treatment apparatus reaches the predetermined pressure according to the control signal.

10. A monitoring apparatus for a device having a mechanism that controls a throughput of a fluid to be supplied to a substrate treatment apparatus or a fluid to be discharged from the substrate treatment apparatus, controlling the throughput to be a throughput according to a control signal pre-corresponding to a control state of the throughput control mechanism when the control signal is entered and transmitting an electric signal indicating the control state of the throughput control mechanism as an output value, comprising:
a unit acquiring the output value;
a unit calculating an output difference value, which is a difference between the acquired output value corresponding to a reference state of the throughput control mechanism before the start of a substrate treatment by the substrate treatment apparatus and the acquired output value corresponding to the control state of the throughput control mechanism during the throughput control according to the control signal acquired in the substrate treatment;
a unit determining whether or not the throughput control is abnormal based upon the output difference value.

11. The monitoring apparatus according to claim 10, further comprising a unit calculating a difference between the output difference value calculated with regard to the throughput control that is subject for abnormal determination and the output difference value calculated with regard to other throughput control completed before the throughput control to be determined, wherein whether or not the throughput control is abnormal is determined by comparing between the calculated difference of the output difference values and a pre-set specification value.

12. The monitoring apparatus according to claim 11, wherein the other throughput control is the throughput control completed immediately before the throughput control that is subject for abnormality determination.

13. The monitoring apparatus according to claim 12, wherein the determination unit accumulates the difference of the output difference values throughout multiple times of throughput controls implemented within a predetermined period and determines whether or not the throughput control is abnormal based upon the accumulated value.

14. The monitoring apparatus according to claim 10, further comprising a unit correcting a zero point of the output value based upon the determination result after each determination by the determination unit.

15. The monitoring apparatus according to claim 10, wherein the device having the throughput control mechanism is a flow controller that adjusts a flow rate of a liquid or gas to a predetermined value, and the reference state is the control state with zero flow.

16. The monitoring apparatus according to claim 10, wherein the device having the throughput control mechanism is a pressure controller that adjusts a pressure within the substrate treatment apparatus to a predetermined pressure, and the reference state is the control state at the time when the inside of the substrate treatment apparatus reaches the predetermined pressure according to the control signal.
